(19) United States
(12) Patent Application Publication
(10) Pub. No.: US 2007/0268831 A1
(43) Pub. Date: Nov. 22, 2007

(54) Method for Network Load Shaping in a Mobile Radio Network

(75) Inventors: Andras Balazs, Ottobrunn (DE); Stefan Rugel, Munchen (DE)

Correspondence Address: STAAS & HALSEY LLP, SUITE 700, 1201 NEW YORK AVENUE, N.W., WASHINGTON, DC, 20005, US

(73) Assignee: SIEMENS AKTIENGESELLSCHAFT, Munich (DE)

(21) Appl. No.: 11/663,642

(22) PCT Filed: Sep. 22, 2005
(86) PCT No.: PCT/EP05/54751

§ 371 Date: Mar. 23, 2007

(30) Foreign Application Priority Data
Sep. 24, 2004 (DE) 10 2004 046 400.6

(51) Int. Cl. H04L 12/56

(52) U.S. Cl. 370/235.1

(57) ABSTRACT

A method for network load shaping in a mobile radio network classifies data packets in a packet data stream according to a leaky bucket classification system and optionally delays the data packets in a network device within the mobile radio core network, in order to smooth burst and hence to reduce loss probabilities and the occurrence of delays in the forwarding of data packets from a data source, over the mobile radio network, to a mobile radio terminal in a simple and economical manner.

### CROSS REFERENCE TO RELATED APPLICATIONS

This application is based on and hereby claims priority to Application No. PCT/EP2005/054751 filed on Sep. 22, 2005 and DE Application No. 10 2004 046 400.6 filed on Sep. 24, 2004, the contents of which are hereby incorporated by reference.

### BACKGROUND

The present invention relates to a method for network load shaping in a mobile radio network, more particularly a GPRS or UMTS network.

A leaky bucket algorithm for limiting the packet data flow in a network device of a mobile radio core network is known from EP 10 75 116 A2.

What is termed a “packet scheduling” method for packet data of a radio communication network is known from WO 03/085903 A1.

In GPRS and UMTS networks data transmission is packet-oriented, i.e. data is transmitted in the form of data packets which form a flow of data between a data source and a mobile radio terminal. In contrast to earlier, circuit-oriented networks (e.g. GSM networks), in packet-oriented networks no exclusive connection with permanently predefined and reserved bandwidth is available to the data flow. Rather, the data packets of a multiplicity of packet data flows are routed over the same connection paths. Thus, the data flows are in competition with one another for the bandwidths that are available at the respective network devices.

A “data flow”, in the present context, is understood as a collection of data packets that is required to be transmitted between a transmitter and a receiver over a network. In this case it may concern, say, the transmission of data between a server and a client, for email transmission for example. However, a data flow may also be a “data stream”, in which case the data rate at the receiver is also relevant in addition to the full transmission of the data, e.g. for telephony or video applications (“streaming media”).

The global internet is likewise based on the principle of packet-switched data transmission. The problems which result from the combined transmission of data flows are also known from this field. Neither individual data flows nor the aggregated data flows that are typical of backbone or core networks and are produced from the merging or, as the case may be, aggregation of a plurality of data flows exhibit a continuous or at least approximately continuous progression in terms of the data transfer rate when they are analyzed at a specific point in the network. Rather, such data flows reveal an irregularity in the data transfer rates that is absolutely characteristic of internet data traffic, said irregularity being referred to as “burstiness”. An individual “burst” is characterized here by a short-lived, abrupt and substantial increase in packet or, as the case may be, data transfer rate compared to an average.

Burstiness leads to the overloading of network devices, which can no longer cope with the multiplicity of incoming packets. There is therefore an increased probability of data packets being lost, since data packets are discarded (“packet loss”) if no buffers are present in the affected device, for example a router, or said buffers are already completely filled with data packets that are to be forwarded.

The overloading also leads to data packets being delayed (“delay”) if they have to be held for a long time in the buffer. Delayed data packets are also delayed in reaching the receiver. Depending on the type of data transmitted, an excessive delay can seriously disrupt the application that processes this data. This applies, for instance, to the transmission of voice data over the internet (“Voice over IP”), where a delay of 300 ms at the latest is perceived as a nuisance by the listener. For this reason telephony applications usually discard data packets which arrive with a corresponding delay. In the event of massive overloading of a network device between transmitter and receiver, the voice connection ultimately collapses.

The simplest way to guarantee reliable forwarding of all data packets in the internet, i.e. to reduce loss and delay, in spite of “burstiness” is to equip all the affected network devices with forwarding capacities which permit even the maximum (peak) data rates occurring during bursts to be handled. However, this so-called “over-provisioning” is expensive, since the peak data rates are generally very much higher than the data rates averaged over relatively long periods of time. Consequently powerfully dimensioned network devices must be provided, the capacities of which are, however, not made use of for the vast majority of the time (if no bursts require processing at this precise moment in time).

Additional mechanisms for dealing with bursts are therefore provided for routers or comparable forwarding network devices. Said mechanisms are typically based on the use of a buffer memory in which data packets belonging to a burst are temporarily stored. A buffer of this kind can be set up for example for each physical connection of the device to neighboring devices in the network. The buffered packets are forwarded at the end of a defined delay time. The burst has thus disappeared, i.e. the resulting data transfer rate corresponds in effect more to an average transfer rate per data flow.

Network devices of said kind can then be embodied for example to record and evaluate special identifiers of data packets and to handle the data packets according to the identifier. For this purpose it must be known to the transmitter which identifier leads to which type of handling so that it can select the data to be sent according to the requirements of the application which requests the data. An example of this is what is referred to as the DiffServ (“Differentiated Services”) mechanism.

Other overload control mechanisms relate to agreements which the end points of a data flow negotiate with one another. The agreement concerns in particular the data rate and in certain situations also the path of the data flow through the network. Traffic control in the network (“traffic policing”) monitors or, as the case may be, enforces compliance with the agreement. An example of this is the RSVP (“ReSerVation Protocol”) mechanism.

The forwarding of data packets in network devices therefore always requires on principle at least two steps, i.e. the step of classifying an incoming data packet and the step of handling said data packet in accordance with a classification result.

In this case the classification can determine a specific class (for example a DiffServ class) or a specific data flow (for example an RSVP data flow) to which the data packet belongs.

In association with the network device, handling rules are stored which specify, for every possible classification result, how the data packet is to be handled. A corresponding handling module can for example release a data packet immediately for forwarding, with the result that said packet is placed in an output queue of the network device and forwarded according to the available physical data transmission capacities. In response to a different classification result the handling module can buffer the data packet in the above-mentioned buffer memory which can also be embodied in the form of a queue. After a certain delay the stored data packet is read out and again supplied to the same or a further classification mechanism. A plurality of classification and handling devices may be present in sequence or else interleaved in a network device.

The classification and handling of data packets in network devices can also take place independently of the data sources and/or sinks in the devices of a network. The term used in this context for network load shaping is “traffic shaping”, which is performed by the network operator with the aim of limiting the peak data rates and burst lengths that occur in data flows arriving at the network.

Although it is possible in principle to handle the burstiness of internet traffic through application of the above-described methods, this is at the cost of increasing complexity of the network devices and where applicable also of the terminal devices. Proposals for solutions must prove their mettle in this context of contradictory priorities. There is a host of said proposals, as documented by the almost inexhaustible abundance of comprehensive technical literature on the topic of bandwidth management in the internet, and which is also evident from the number of corresponding working groups of the standardization body for the internet, the IETF (“Internet Engineering Task Force”). No solution that is equally optimal for all applications and network devices has so far been found.

The problems described also present themselves in GPRS and UMTS networks, since in this case data flows from data sources from the general internet can be downloaded to mobile radio terminals.

In order to provide improved data reception quality for mobile radio terminals, efforts in the related art have mainly been concentrated on the air interface, i.e. the point of transition from the mobile radio network to the terminal, since the bandwidth available along the path from the data source to the data sink in the terminal is most seriously restricted in any case at this point.

“GPRS flow control” in accordance with the 3GPP specification TS 08.18 is known in order to avoid loss and delay as far as possible at the air interface. The GPRS flow control protects the buffer in the BSC/PCU disposed upstream of the air interface. At this point the transmission capacity is reduced to the bandwidth that is actually available on the air interface. The GPRS flow control regulates the traffic per cell (“BVC Flow Control”) and per subscriber (“MS Flow Control”, cf. FIG. 8.1 in TS 08.18).

An algorithm (FIG. 8.2) is used for the flow control in which the fill level of the buffer or, as the case may be, bucket and the leak rate in the BSC is simulated on the SGSN. The size of the bucket and the leak rate are communicated to the SGSN by the BSC. In the case of overload the data packets are buffered in the SGSN, which enables the transport to be prioritized in accordance with 3GPP QoS principles.

It is known from the publication by H. Jiang, C. Dovrolis, “Source-Level IP Packet Bursts: Causes and Effects”, Proceedings of the 2003 ACM SIGCOMM conference on Internet measurement, that at least one important cause of bursts lies in the generation of the data flow at the data source. In this case mechanisms such as, for example, UDP message segmentation and the concatenation of a plurality of transfers within an existing TCP connection result in a large number of data packets which far exceed the average data rate being transmitted by the data source in a short time.

A significant statement of the publication is furthermore that the presence of such “source level IP packet bursts” in individual data flows also has a major impact on aggregated data traffic. Accordingly it is recommended that data sources be configured in such a way that packet bursts of said kind also do not occur even in individual data flows.

A network load shaping method for UMTS/GRPS networks that is known from 3GPP TS 23.107 (“traffic shaping”) aims in this direction. In this case a “maximum bit rate” is defined as a maximum number of bits entering the mobile radio network via a network access point (“Service Access Point”, SAP) during a specific period of time, divided by the duration of said period of time. Data traffic conforms to this maximum data rate if it is formed in accordance with a token bucket algorithm, where the token rate is equal to the maximum bit rate and the bucket size is equal to the maximum SDU (“Service Data Unit”) size (cf., for example, Section 6.4.3.1 in TS 23.107).

The Maximum Bitrate is the only parameter for controlling the bit rate specified for the QoS classes “Interactive” and “Background” in TS 23.107. The purpose here is to define a maximum bit rate for data flows at the borders of the mobile radio network. In particular the aim is to limit the data rate on the application side, as can be gathered from the passages concerning the two traffic classes in Section 6.4.3.2 of TS 23.107.

Ideally, therefore, the traffic would have to be shaped by a data flow handling module close to the data source. For this purpose TS 23.107 proposes a “conditioner” on the input side of a gateway, cf. FIG. 3 of TS 23.107.

However, network load shaping of this kind has hardly become widely established up to now. No maximum bit rates are provided by the operators of mail servers or web servers for typical applications such as, for example, web browsing or email downloading. The operators of data sources anywhere on the internet generally also have no incentive to introduce corresponding bandwidth restrictions on a blanket basis on account of the requirements of mobile radio network operators.

Consequently, an architecture as indicated in FIG. 3 of TS 23.107 can lead to a reduction in burstiness in the core network and radio access network (RAN) of a mobile radio operator only in exceptional cases, if, for example, the data source belongs to the mobile radio network or the operator of the network has made a corresponding agreement with the data provider.

### SUMMARY

One possible object of the invention is therefore to reduce, in a simple and cost-effective manner, loss probabilities and the occurrence of delays in the forwarding of data packets from a data source via a mobile radio network to a mobile radio terminal, as well as to propose correspondingly equipped network nodes.

As explained above, bandwidth management in relation to mobile radio networks has previously concentrated on the transfer of data via the air interface, as is the case, for example, with the GPRS flow control according to TS 08.18, but also with network load shaping (“traffic shaping”) according to TS 23.107 (cf. in FIG. 3 therein the “conditioner” at the boundary of the radio access network (RAN) with the mobile radio terminal). Conversely, it is communicated in the above-mentioned article by Jiang & Dovrolis that in order to smooth data traffic it is necessary to concentrate on the data source, as is also to be inferred from TS 23.107.

The inventors propose breaking away from this orthodox thinking and including the network devices in the interior of the core network in the considerations.

By way of explanation, FIG. 1 shows a highly schematized GPRS network comprising the core network components GGSN and SGSN and the radio access network component BSC/PCU.

Several 10 Mbps of bandwidth is initially still available for a data flow originating from a data source (Server) in the general internet as well as upon entry into the mobile radio core network via the Gi interface at the GGSN. This bandwidth is sufficient for transmitting, for example, moving images in the course of a video telephony session; such data flows are typically sent at 2 Mbps. This is significantly less than the available capacity (at least for an individual data flow of said kind), so sufficient bandwidth is also available for any bursts that may occur in the stream.

In the core network the data flow is forwarded via the Gn interface to that SGSN which is responsible for servicing the mobile radio terminal (MS) which represents the destination point of the data flow. Although large bandwidths are still also available at the Gn interface, problems can occur here already due to the burstiness of one or more data flows, since the Gn interface or, as the case may be, the downstream (in the downlink direction, i.e. the direction pointing toward the terminal) SGSN is an aggregation point at which numerous data flows converge.

During the forwarding of a data flow from the core network into the radio access network the available bandwidth is greatly reduced, to typically 2 Mbps. Furthermore the air interface Abis/Um between radio access network and mobile radio terminal is a point at which bursts lead to increased loss probability and/or delays in the packet data transport. At this point, namely, the bandwidth available for the transmission of one or more data flows is generally reduced considerably, for example from the original several 10 Mbps to less than 1 Mbps.

However, the burstiness of the packet data traffic is a problem not only at the air interface, but also at the further, above-mentioned interfaces or points in the mobile radio network, potentially resulting in the buffers in the GGSN, SGSN, BSC/PCU being overloaded due to a burst occurring in a data flow and data packets of this or other data flows being delayed or having to be discarded.

From this it becomes understandable that the GPRS flow control also does not solve the problem of loss and delay during the reception of data flows in terminals:

1. The GPRS flow control protects the bottleneck at the air interface, but not the collision and aggregation points at the Gn interface. Aggregation points also exist in the core network or at the boundary to the radio access network, in particular adjacent to the Gb or Gn interface. Furthermore, the available bandwidth per data flow is also reduced at the Gb interface.

2. If the capacity of the bucket on the SGSN is not exhausted, the specification permits the SGSN to send the data packets at an unlimited rate to the BSC. The token rate limits the throughflow in the BSC direction only when the bucket is used up. Since in practice the sizes of the bucket can easily lie in the region of 50 Kbytes or more for the BVC flow control as well as for the MS flow control, short-lived bursts pass through the SGSN unrestricted.

This is due to the fact that the bucket size has a direct influence on the smoothing of the bursts. Incoming data packets whose aggregated total length does not exceed the bucket size are forwarded immediately. Consequently, a burst including a plurality of packets is not intercepted if its total length remains under the bucket size. A burst of this kind passes through the network device unchanged.

The GPRS flow control thus also does not offer adequate protection for the area between SGSN and BSC, the Gb interface. A critical point here is above all the SGSN-side output of the NSVCs (“Network Service Virtual Circuits”) to the BSC via the Gb interface. At this point the bandwidth is reduced to 64 kbps to max. 2 Mbps (Frame Relay). Moreover the traffic to a plurality of mobile radio cells is combined here, so mutual blocking of individual traffic data flows can occur.

Thus, a suitable method for network load shaping should realize a bandwidth management system in the core network in order to be able to significantly reduce loss probabilities and delays of data packets for a data flow between a data source located internally or externally with respect to the mobile radio network to a mobile radio terminal connected to the mobile radio network.

It is proposed to limit the data rate of a data flow within the core network to a maximum data rate. The excess traffic is buffered to an appropriate extent, i.e. equivalent to the size of the bursts that are to be expected.

Toward that end a classification scheme formed on the basis of a leaky bucket algorithm will need to be implemented in a network device of the core network. Such algorithms are widely employed for classifications and handling of data flows, so existing algorithms and implementations or, as the case may be, software modules can be used for this algorithm and the implementation of the method is rendered particularly easy.

Basic parameters of such an algorithm are always a leak rate, which corresponds to a predefined maximum data rate, and a maximum bucket size. The bucket size of the leaky bucket algorithm should be large enough to keep data loss to a minimum. In any event it must be possible to store considerably more than one packet.

The token bucket algorithm to be used according to TS 08.18 provides a bucket size of the size of at least one packet data unit (PDU). However, the typical bucket size should be sufficient to buffer the data flow to a mobile radio terminal for a period of 1 second. Approx. 8.8 Kbytes is cited as an actual typical bucket size, cf. Section 8.2.3.6. As noted above, however, the bucket size can also readily become as large as 50 Kbytes.

In a further step of the method the condition is tested as to whether, during the forwarding of one data packet from a series of consecutive data packets of a packet data flow, the bandwidth predefined by the maximum data rate for the transmission of the packet data flow would be exceeded. If this is the case, it is additionally checked whether the total length of the data packets would exceed the maximum bucket size. If both conditions are met, the packet is delayed.

In an algorithm with a relatively large bucket size, as in the case of the GPRS flow control according to TS 08.18, the maximum data rate is maintained only over relatively long periods of time, since a burst with a total data size less than or equal to the maximum bucket size is not smoothed. With the very small bucket size, bursts cannot pass through the network devices in the core network.

With a conventional token bucket method it must be continually checked whether a current bucket counter, corresponding to a current “fill level” of the bucket, exceeds the maximum bucket size.

By contrast, the advantages of the method lie in the simple implementation. Moreover, contrary to a continuous flow control, little CPU capacity is required.

In an advantageous embodiment of the method, the packet data flow comprises in particular that packet data which is assigned to a logical connection between the mobile radio terminal and the network device, in particular in a PDP context. The logical connection therefore relates to data of a particular data type which is transmitted from a data source to the mobile radio terminal.

The method can be implemented particularly easily and therefore advantageously in the SGSN and/or GGSN of the core network of a GPRS/UMTS mobile radio network, since the current parameter set for currently activated PDP contexts is present in these in each case. These can therefore be easily accessed in order to read out the value of the maximum data rate or, as the case may be, “maximum bit rate” for the data flow to be handled.

The maximum data rate is a component part of the PDP context parameters. Access to the data packets is possible down to LLC level via the header information of the data packets. This value can then be assigned to the leak rate of the leaky bucket algorithm used according to the invention.

A combination of the method with the flow control according to TS 08.18 in an SGSN is straightforwardly possible. For this purpose the method is preferably applied downstream of the flow control. In particular the maximum transmission rate of MSC and BVC flow control in the SGSN is limited to the maximum data rate.

In a further preferred embodiment, the excess traffic per packet data flow is buffered in a buffer or, as the case may be, queuing memory. The latter has a storage space of sufficient size to enable data packets to be buffered to an extent determined by typical bursts occurring in the core network. In this case source-level bursts caused by the data source of the packet data flow should be taken particularly into account. If the buffer is full, further, excess data packets are discarded.

### BRIEF DESCRIPTION OF THE DRAWINGS

These and other objects and advantages will become more apparent and more readily appreciated from the following description of the preferred embodiments, taken in conjunction with the accompanying drawings of which:

FIG. 1 shows a schematic representation of the bandwidths available at important interfaces or, as the case may be, reference points in a GPRS network,

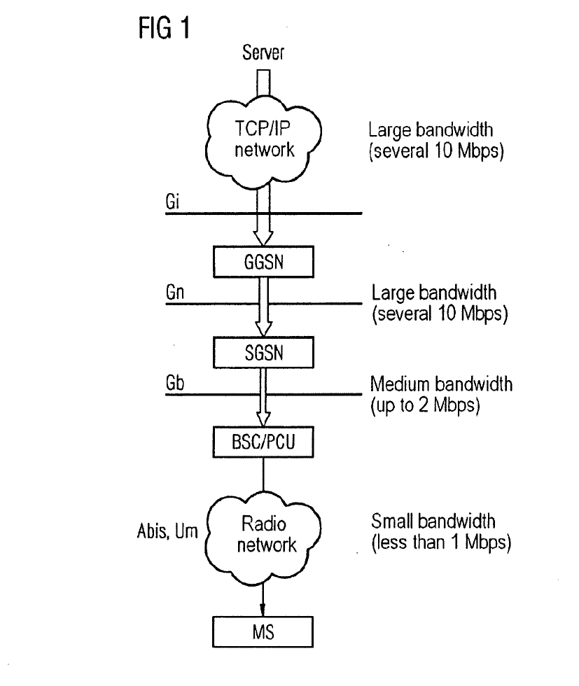

FIG. 2 shows a schematic representation of a GPRS network with SGSN and GGSN further developed,

FIG. 3 is a flow chart intended to illustrate a proposed rate limiting algorithm for conformance testing,

FIG. 4 shows a functional block diagram of proposed components of an SGSN/GGSN from FIG. 2.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

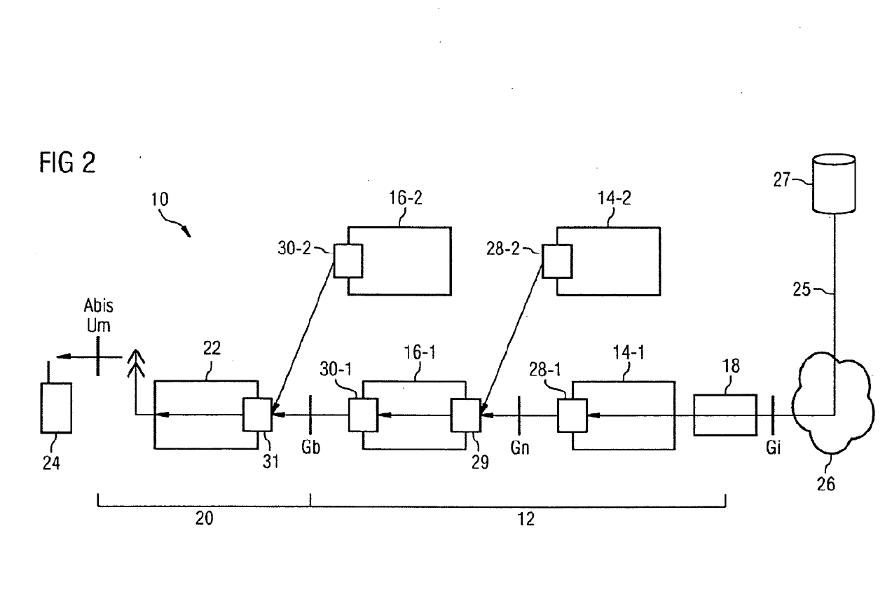

FIG. 2 shows network devices or network elements of a GPRS mobile radio network 10 in schematized form. The core network 12 of the mobile radio network 10 includes two GGSNs 14-1 and 14-2 as well as two SGSNs 16-1 and 16-2. Also present in the core network 12 is a gateway 18 which performs functions of a data flow shaping according to TS 23.107 and which is described in more detail below. The radio access network 20 of the mobile radio network 10 includes a BSC/PCU 22. Via said mobile radio network 10 a mobile radio terminal 24 receives data from an external data source 27 connected via an external packet data network 26 as part of a data flow 25.

In this case the data flow 25 relates to data transmitted as part of a PDP context activated for the terminal 24 in the GGSN 14-1 and SGSN 16-1. The data flow includes TCP packets used by an application, specifically a web browser on the terminal 24, in order to represent a website. Other data services could, of course, equally well be cited as examples, e.g. email downloading or similar download services.

Packet data flows such as the flow 25 are represented by unbroken arrowed lines. Interfaces or reference points between the network devices and at the network boundaries are provided with the designations “Gi”, “Gn”, etc., as known to the person skilled in the art from the 3GPP UMTS/GPRS specifications.

The data flow 25 is generated in the data server 27 in response to a request originating from the terminal 24 and sent from there to the mobile radio network 10 at a data rate that is dependent on the configuration of the server 27. In the example illustrated here let it be assumed that the data rate is 10 Mbps. Bursts can occur in which the data rate increases to a multiple of 10 Mbps for several 10 milliseconds to several 100 milliseconds.

Upon entry into the network 10 at the Gi interface embodied by the gateway 18, this data rate is modified in its time progression by the conditions prevailing in the external network 26. It is therefore conceivable that additional bursts occur in the data flow.

The gateway 18 is formed in accordance with the TS 23.107 specification in order to adapt the data rate of the data flow 25 to the conditions of the mobile radio network 10, in reality to the available bandwidths in the core network 12 and radio access network 20. The gateway 18 could also be implemented as part of the GGSN 14-1, though in this case it is drawn as a standalone unit in order to illustrate that the network load (“traffic”) shaping in accordance with TS 23.107 takes place on the outside of the mobile radio network 10. According to TS 23.107 further units for network load shaping, relative to the path of the downlink data flow 25 to the terminal 24, are only provided again in the BSC/PCU 22 in order to adapt the data flow to the bandwidth capacity over the air interface.

In the GGSN 14-1 the data flow 25 (possibly together with further data flows that are not drawn specifically) is output via a network interface unit 28 in the direction of the SGSN 16-1. The interface unit 28-1 operates in a known manner in order to adapt the data flow 25 to the Gn interface.

The interface unit 29 in the SGSN 16-1 represents an aggregation point. As shown in the example in FIG. 2, data flows of the GGSNs 14-1 and 14-2 are merged at this point. If a burst now occurs in only one of the data flows combined in the unit 29, this can noticeably disrupt the aggregated data flow, as shown in the publication by Jiang & Dovrolis.

The same applies in the example shown in FIG. 2 on the input side at the BSC/PCU 22, where data flows of the SGSNs 16-1 and 16-2 are aggregated in the receiving interface unit 31.

Although the interface units 29 and 31 are embodied for receiving aggregated data flows in each case with an average bandwidth or, as the case may be, at an average data transfer rate, if a burst occurs in one of these data flows, the capacity of the input queue of the unit may be overextended, with the result that packets have to be greatly delayed or even discarded.

In order to avoid loss and delay occurring in data flows such as the data flow 25 during their passage through the mobile radio network 10, the interface units 28-1, 28-2 and 30-1, 30-2 positioned upstream of the aggregation points are further developed in order to reliably prevent the occurrence of bursts in the data flows.

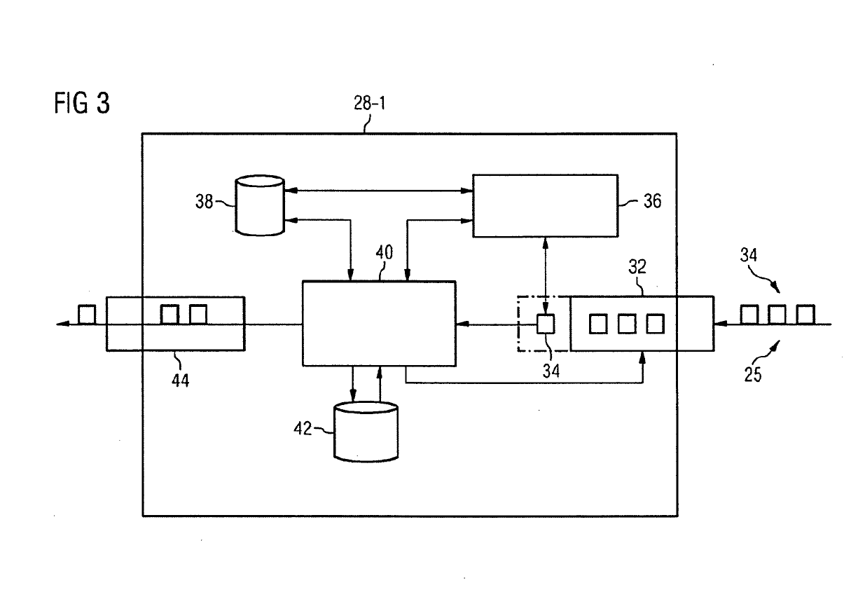

By way of more precise explanation FIG. 3 shows components of the interface unit 28-1 that are used with the proposed method and network device. The layout of the units 28-2, 30-1 and 30-2 corresponds to that of the unit 28-1.

The interface unit 28-1 initially has an input queue 32. Data packets 34 of the packet data flow 25 are placed in said queue by the server 26 together with packets of further data flows that are intended to be forwarded by the GGSN 14-1 via the Gn interface to the SGSN 16-1. Some of the data packets 34 are represented schematically in FIG. 3.

A classification module 36 is implemented for the purpose of classifying the data packets 34 contained in the input queue 32. In order to perform the classification the module 36 accesses a constant memory 38, as will be described in more detail below. The classification result is passed to a handling module 40. The module 40 is embodied to store data packets 34 that may require buffering in a buffer 42 in accordance with the classification result, to retrieve the buffered packets from the buffer 42, and to place them back in the input queue 32 after buffering. Packets that are not to be buffered are adapted by the handling module to the format of the Gn interface and placed in an output queue 44, from which the packets 34 to be forwarded to the SGSN 16-1 are taken and forwarded in accordance with the physical capacity of the connection between GGSN 14-1 and SGSN 16-1.

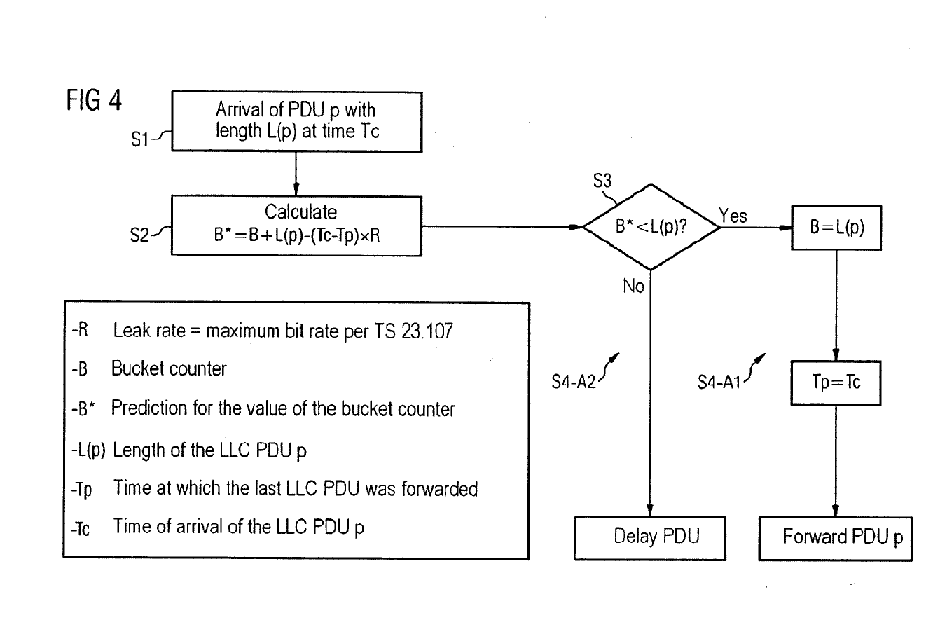

The principle of operation of the classification module 36 is described with the aid of steps S1 to S10 of the flow chart of FIG. 4. In step S1 a check is made to determine whether at least one data packet 34 is present in the input queue 32. If that is the case, the length of the first packet 34 present in the queue is determined by the classification module 36 (according to the FIFO principle). For this purpose the length L(p) of the packet data unit (PDU) in the LLC (“Logical Link Control”) protocol layer of the packet p to be classified is determined.

In step S2 a prediction value of the so-called “bucket counter” B* is determined using L(p). This is calculated as the sum of the lengths of the last packet and of the packet that is now to be handled, less the desired maximum bit rate, multiplied by the time that has elapsed since the sending of the preceding packet.

This prediction value is compared in step S3 with the length of the packet L(p) determined in step S1. If the prediction value B* is smaller, the forwarding of the packet p would be in line with the maximum bit rate R. The packet p can therefore be forwarded.

For this purpose, in a step S4-Al (Alternative 1), a corresponding classification result “forward PDU” is passed to the handling module 40. In addition the algorithm used in step S2 is prepared for the classification of the next packet, in which the bucket count is set to the length of the packet just classified and the time of the sending of the last packet is set to the current time.

If, on the other hand, the result obtained in step S3 is that the sending of the packet to be classified would lead to the maximum bit rate R being exceeded, a corresponding classification result “delay PDU” is passed in a step S4-A2 to the handling module 40, and no updating of the parameters B and Tp takes place.

In order to determine the value of the bucket count B* in step S2, the classification module 36 accesses the constant memory 38 (cf. FIG. 3) in which the value of the maximum data rate or “maximum bit rate” R is stored. The maximum bucket size of the bucket implemented in the classification module 36 does not need to be stored, since the condition as to whether the bucket size would be exceeded if the packet to be classified in each case is transmitted does not have to be determined and evaluated. The implementation of the leaky bucket mechanism is simplified compared with token bucket algorithms, e.g. according to TS 23.107. This leads to a reduction in the CPU processing times required for classifying the packets in the module 36.

The classification module 36 is embodied for reading out the value of the maximum bit rate of the activated PDP context parameter set assigned to the terminal 24 and the packet data flow 25 from a PDP context memory (not shown) of the GGSN 14-1 and for storing said value in the constant memory as a constant parameter for the leak rate R of the algorithm .

If the handling module 40 receives the classification result “forward PDU” from the classification module 36, the handling module 40 removes the first packet 34 from the queue 32 and forwards it in the direction of the SGSN 16-1 (cf. FIG. 2).

If the handling module 40 receives the classification result “delay PDU”, the module 40 removes the packet to be handled from the queue 32 and stores it in the buffer 42. At the same time a timer (not shown) is started in the handling module 40. After the timer has run down, the handling module 40 removes the buffered packet from the buffer 42 and places the packet back in the input queue 32. The value of the timer running down in the module 40 can be obtained for example from the constant R (maximum data rate) stored in the constant memory 38, by calculating a delay period with the aid of R and the length of the packet. In this way a packet, at the end of its delay, is supplied once more for classification by the module 36 and is then either forwarded or delayed again.

The bucket size for the token or, as the case may be, leaky bucket algorithms that are implemented on the gateway 18 and in the interface unit 28-1 can assume different values, since the two units serve different purposes. The gateway 18 scales the data flow 25 in respect of the quality-of-service requirement of the bearer service used for the data flow 25 in the mobile radio network 10. The interface unit 28-1 implemented on the output side in the GGSN 14-1 serves to avoid packet losses and delays due to the aggregation points present particularly in the core network 12.

On the other hand, the maximum data rate (i.e. the maximum bit rate) per PDP context should be the same at all points, regardless of the network configuration. If the maximum data rate were to be smaller at one point than the maximum bit rate specified in the PDP context, the maximum bit rate could no longer be guaranteed.

The data flow 25 is furthermore subjected to a GPRS flow control in accordance with TS 08.18 (not shown) in the SGSN 16-1. In this case this is geared to the performance of the buffer for the air interface in the BSC 22. However, network load shaping that eliminates bursts does not take place, since the flow control in accordance with TS 08.18 provides a bucket size up to approx. 50 Kbytes or more.

The aggregation point in the BSC/PCU 22 is protected by the units 30-1 and 30-2 which are embodied corresponding to the interface units 28-1 and 28-2. In the BSC 22, finally, the data flow 25 is subjected to further shaping in accordance with TS 23.107 (not shown). This ensures that the data flow 25 transmitted over the air interface Abis/Um to the terminal 24 is formed consistent with the GPRS bearer service used.

The constant memory 38 in FIG. 3 can be a memory on which the parameter values for activated PDP contexts are stored.

Instead of being implemented in each case on network interface units, as in the example presented here, the method can also be implemented on standalone units of the network nodes in the mobile radio network. The interface units further developed (in the example shown in FIG. 2, the units 28-1, 28-2, 30-1, 30-2) are in each case disposed in respect of downlink data flows upstream of aggregation points requiring protection or points at which the available bandwidth is reduced. Generally the points in the mobile radio network at which data flows are to be limited or, as the case may be, smoothed should be chosen such that no further bursts can arise between said points and the aggregation points requiring protection.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-11. (canceled)

12. A method for network load shaping in a GPRS or UMTS mobile radio network, the mobile radio network having a radio access network and a core network, comprising:
forwarding a packet data flow from a data source to a mobile radio terminal via a network device in the core network and via the radio access network.
classifying data packets of the packet data flow in the network device, the data packets being classified on the basis of a leaky bucket algorithm, the leaky bucket algorithm having a leak rate from a bucket corresponding to a predefined maximum data rate.
performing classification in such a way that a predetermined classification result is obtained for data packets of a series of consecutive data packets if transmission of the data packets in the packet data flow would exceed a maximum data rate. and
handling each data packet in the mobile radio network according to the classification result, the data packets being delayed in forwarding to the mobile radio terminal if the predetermined classification result has been assigned thereto, the data packets being delayed such that the predefined maximum data rate is maintained during transmission of data packets from the network device to the mobile radio terminal, wherein
the packet data flow includes packet data assigned to a logical PDP context connection between the mobile radio terminal and the network device,
the packet data assigned to the logical PDP context connection has an activated PDP context parameter assigned thereto,
the activated PDP context parameter is accessed in order to read out a maximum bit rate and assign a leak rate, and
a supplementary check is performed and the data packets are delayed only if the supplementary check shows that the data packets have a total length that exceeds a maximum bucket size.

13. The method as claimed in claim 12, wherein
the data packets are classified is reduced in such a way that no new bursts can arise between the network device and the aggregation point and/or the point at which the maximum available bandwidth is reduced.

14. The method as claimed in claim 12, wherein
the data packets are classified upstream from a General Packet Redo Service (GPRS) Gn or Gb interface.

15. The method as claimed in claim 12, wherein
the maximum data rate for traffic classes ‘Interactive’ and ‘Background’ is determined according to the maximum bit rate of 3GPP specification TS 23.107.

16. The method as claimed in claim 12, wherein
the data packets are classified and handled in an SGSN or GGSN.

17. The method as claimed in claim 12, wherein
the data source is external to the mobile radio network, and
network load shaping is performed according to 3GPP specification TS 23.107 (“traffic shaping”) in the radio access network and/or at the data source, and/or
flow control according to 3GPP specification TS 08.18 is performed in the core network upstream of a Gb interface.

18. The method as claimed in claim 17, wherein
the data packets of the packet data flow are classified and forwarded or delayed in a SGSN following the flow control according to the 3GPP specification TS 08.18.

19. The method as claimed in claim 12, wherein
delayed data packets are buffered in a buffer having a predefined amount of storage space,
data packets for which insufficient storage space is available for buffering are discarded, and
the storage space is predefined in such a way that data packets can be buffered to accomodate bursts occurring in the core network.

20. The method as claimed in claim 13, wherein
the data packets are classified upstream from a General Packet Redo Service (GPRS) Gn or Gb interface.

21. The method as claimed in claim 20, wherein
the maximum data rate for the traffic classes ‘Interactive’ and ‘Background’ is determined according to the maximum bit rate of 3GPP specification TS 23.107.

22. The method as claimed in claim 21, wherein
the data packets are classified and handled in an SGSN or GGSN.

23. The method as claimed in claim 22, wherein
The data source is external to the mobile radio network,
network load shaping is performed according to 3GPP specification TS 23.107 (“traffic shaping”) in the radio access network and/or at the data source, and/or
flow control according to 3GPP specification TS 08.18 is performed in the core network upstream of a Gb interface.

24. The method as claimed in claim 23, wherein
the data packets of the packet data flow are classified and forwarded or delayed in a SGSN following the flow control according to the 3GPP specification TS 08.18.

25. The method as claimed in claim 24, wherein
the delayed data packets are buffered in a buffer having a specific amount of storage space is predefined,
data packets for which insufficient storage space is available for buffering are discarded, and
the storage space is predefined in such a way that data packets can be buffered to accomodate bursts occurring in the core network.

26. A network device for a core network of a GPRS or VMTS mobile radio network comprising:
a classification module in which a classification scheme based on a leaky bucket algorithm is implemented to classify data packets of a packet data flow arriving at the network device from a data source, which data packets are to be forwarded to a mobile radio terminal connected to the mobile radio network, the leaky bucket algorithm having a leak rate corresponding to a predefined maximum data rate, the classification module assigning a classification result to each data packet;
a constant memory for storing predefined constants for the classification scheme, and
a handling module for handling the data packets according to the classification result assigned thereto, wherein
in order to classify the data packets, the classification module reads out a constant from the constant memory, and assigns the classification result based on the constant and data relating to the data packet,
the classification module passes the classification result to the handling module,
the packet data flow includes that packet data assigned to a logical PDP context connection between the mobile radio terminal and the network device,
the packet data assigned to the logical PDP context connection has an activated PDP context parameter assigned thereto,
the activated PDP context parameter is accessed in order to read out a maximum bit rate and assign the leak rate, and
there is a delay in forwarding the data packets if, in a supplementary check, the data packets have a total length that exceeds a maximum bucket size.

27. The network device as claimed in‘claim 26, wherein
the network device is an SGSN or a GGSN.

28. The network device as claimed in claim 26, wherein
the classification module reads out the maximum bit rate from a PDP context memory in the network device, by referring to the activated PDP context parameter, and
the classification module stores the maximum bit rate in the constant memory as a constant for the leak rate.

29. The network device as claimed in claim 27, wherein
the classification module reads out the maximum bit rate from a PDP context memory in the network device, by referring to the activated PDP context parameter, and
the classification module stores the maximum bit rate in the constant memory as a constant for the leak rate.
